(19) United States
(12) Patent Application Publication
(10) Pub. No.: US 2024/0269866 A1
(43) Pub. Date: Aug. 15, 2024

(54) GRIPPING DEVICE AND ASSEMBLING MACHINE EQUIPPED WITH THE SAME

(71) Applicant: C&M Robotics Co., Ltd., Seoul (KR)

(72) Inventor: Sang Wan Joo, Seoul (KR)

(21) Appl. No.: 18/433,738

(22) Filed: Feb. 6, 2024

(30) Foreign Application Priority Data
Feb. 13, 2023 (JP) 2023-20024

(51) Int. Cl. B25J 15/00; B25J 15/08; B25J 15/10; B25J 19/00

(52) U.S. Cl. CPC B25J 15/0047; B25J 15/083; B25J 15/10; B25J 19/0075

(57) ABSTRACT

Proposed are a gripping device and an assembling machine equipped with the same, the gripping device comprising a center error correction mechanism which has an upper structure, a lower structure and a limiter and a gripping finger opening and closing mechanism which has gripping finger fixed slide members and an actuator, so that, when the object is press-fitted into the fitting hole, the press-fitting force acting on the gripping fingers acts on the assembling machine through the gripping finger fixed slide members, the lower structure, elastic bodies, the limiter and the upper structure.

### CROSS REFERENCE TO RELATED APPLICATION

The present application claims priority to Japanese Patent Application No. 2023-20024, filed on Feb. 13, 2022, the entire contents of which is incorporated herein for all purposes by this reference.

### BACKGROUND OF THE INVENTION

### Field of the Invention

The present invention relates to a gripping device attached to an assembling machine for gripping and press-fitting an object into a predetermined fitting hole, and an assembly machine equipped with the same.

### Description of the Related Art

Conventionally, when an object such as a shaft or a bearing is press-fitted into a predetermined fitting hole, it is gripped by a gripping tool attached to an operating end part of a robot or press-fit machine. For example, the Japanese Patent Application Publication No. 2003-117738 discloses an invention that allows a bearing holder to hold an object and press-fit it into a fitting hole while correcting the center position.

However, in the press fitting operation using the disclosed invention described above, a general-purpose gripping tool such as a gripper is not usable due to its low load bearing capacity. Consequently, a dedicated gripping tool having a high load bearing capacity for each object is manufactured, such as a bearing holder in the disclosed invention described above. Therefore, in a production line such as in the automobile factories where objects of various types and sizes (bearing, oil seal, pin, shaft, gear, etc.) are press-fitted, it is necessary to prepare a special gripping tool for each work part, and there is a problem that it costs a lot of money for its design and production costs.

Further, the production line is temporarily stopped every time the object to be press-fitted is changed, the gripping tool used up until then is removed, and a new gripping tool needs to be mounted at an accurate position. For this reason, the more kinds and sizes of objects to be handled, the more labor and time it takes to replace the gripping tool, which reduces productivity and causes a large work burden on workers.

Furthermore, when correcting the center position while pressing an object into a fitting hole, an elastic centering device such as the disclosed invention described above is attached. However, if the elastic centering device and the gripping tool which have independently separated functions are serially coupled together, the configuration becomes complicated and the length in the press fitting direction becomes longer. Consequently, rigidity as a whole of the device is reduced and posture becomes unstable, so there is a possibility that press fitting work cannot be performed.

### SUMMARY OF THE INVENTION

Accordingly, the present invention is designed to solve such conventional problems, and the object of the present invention is to provide a gripping device and assembling machine equipped with the same where the function of gripping various objects and the function of correcting a center position when the object is pressed into the fitting hole are integrated without lowering rigidity and stability as a whole configuration, so that which can reduce costs and increase productivity.

In order to achieve the above object, the present invention provides a gripping device attached to an assembling machine for gripping and press-fitting an object into a predetermined fitting hole, the gripping device comprising: a gripping finger opening and closing mechanism for opening and closing a plurality of gripping fingers for gripping the object; and a center error correction mechanism for correcting center position when press-fitting the object into the fitting hole, wherein the center error correction mechanism comprises an upper structure fixed to the assembling machine, a lower structure provided swingably to the upper structure through a plurality of elastic bodies, and a limiter provided between the upper structure and the lower structure for limiting press-fitting force acting on the elastic bodies at least during center position correction or press-fitting when press-fitting the object into the fitting hole, and the gripping finger opening and closing mechanism comprises a plurality of gripping finger fixed slide members provided so as to slide in the radial direction with respect to the center of the lower structure for detachably fixing each of the gripping fingers, and an actuator for slidably moving the plurality of gripping finger fixed slide members in radial direction in accordance with the size of the object, so that when the object is press-fitted into the fitting hole, the press-fitting force acting on the plurality of gripping fingers acts on the assembling machine through the plurality of gripping finger fixed slide members, the lower structure, the plurality of elastic bodies, the limiter and the upper structure.

According to an aspect of the present invention, to solve the problem of gripping various objects while having a compact and stable configuration, the gripping finger fixed slide member may have a gripping finger fixing part for fixing the gripping finger and a slide part having a wider width than the gripping finger fixing part, and the gripping finger opening and closing mechanism may have a support cover provided with a sliding fitting groove fixed to the lower structure and slidably fitting the slide part and a sliding through groove for slidably penetrating the gripping finger fixing part, a driving rod moved up and down by the actuator, and an L-shaped link member whose one end is linked to the driving rod and the other end is linked to the gripping finger fixed slide member for converting the vertical motion of the driving rod into the sliding motion of the gripping finger fixed slide member by rotating around a substantially horizontal rotary shaft provided in the lower structure.

According to an aspect of the present invention, to solve the problem of gripping a wide variety of objects in a simple configuration, the gripping finger fixed slide member may have a gripping finger fixing part fixing the gripping finger and a slide part having a wider width than the gripping finger fixing part, and a T-shaped inclined groove having at the base end part of the slide part an inclined guide surface inclined at a predetermined inclination angle and an inclined surface parallel to the inclined guide surface and formed into a substantially T-shaped cross section, the gripping finger opening and closing mechanism may have T-shaped slots provided in the lower structure and having a substantially T-shaped cross section for slidably fitting the gripping finger fixed slide members and radial arm members vertically moved by the actuator and radially extended toward each of the gripping finger fixed slide members, and a T-shaped inclined piece provided at each end of the radial arm members and having a substantially T-shaped cross section to have an inclined surface parallel to the inclined guide surface and the inclined surface of the T-shaped inclination groove, and sliding along the inclined guide surface and the T-shaped inclined groove for converting the vertical motion of the radial arm members into sliding motion of the gripping finger fixed slide members.

According to an aspect of the present invention, to solve the problem of lightening the lower structure, making it easy to correct the center error, and reducing complicated processing to manufacture easily and inexpensively, the gripping finger opening and closing mechanism may have sliding through grooves provided in the lower structure and enabling the gripping finger fixed slide members to slidably penetrate, slide covers fixed to the upper surface of the gripping finger fixed slide members which penetrate into the sliding through grooves, a driving rod moved up and down by the actuator, a pair of wire hooks fixed at the upper and lower positions of the driving rod, a pair of horizontally fixed rollers rotatably supported around rotating shafts in an approximately horizontal direction at both ends of the sliding through grooves, and a driving wire having one end and the other end fixed to each of the wire hooks and intermediate parts fastened and fixed between the slide cover and the gripping finger fixed slide members and wound around the pair of horizontally fixed rollers for converting vertical motion of the driving rod into sliding motion of the gripping finger fixed slide members.

According to an aspect of the present invention, to solve the problem of transmitting rotational motion of a motor without hindering oscillation during center error correction, the gripping finger opening and closing mechanism may have sliding through grooves provided in the lower structure and enabling the gripping finger fixed slide members to slidably penetrate, slide covers fixed to the upper surface of the gripping finger fixed slide members which penetrate the sliding through grooves, a pair of vertically fixed rollers arranged outside the sliding direction of the sliding through grooves respectively and rotatably supported around rotating shafts in approximately vertical direction, a driving pulley rotatably driven around a driving shaft in approximately vertical direction by the actuator which is fixed to the upper structure, a driven pulley provided in the lower structure and rotated in interlock with the driving pulley, an intermediate pulley provided between the driving pulley and the driven pulley and slidably connecting the driven pulley to the driving pulley in two directions orthogonal to each other, and a driven wire having one end and the other end fixed to the driven pulley and intermediate parts fixed to the slide covers and wound around the pair of vertically fixed rollers for converting rotational motion of the driven pulley into sliding motion of the gripping finger fixed slide members.

According to an aspect of the present invention, to solve the problem of manufacturing easily and cheaply by reducing the number of parts, the gripping finger opening and closing mechanism may have sliding through grooves provided in the lower structure and enabling the gripping finger fixed slide members to slidably penetrate, slide covers fixed to the upper surfaces of the gripping finger fixed slide members which penetrate the sliding through grooves, a pair of vertically fixed rollers arranged outside the sliding direction of the sliding through grooves respectively and rotatably supported around rotating shafts in an approximately vertical direction, a rotary pulley rotated and driven around a driving shaft in an approximately vertical direction by the actuator fixed to the lower structure, and a driving wire having one end and the other end each fixed to the rotary pulley and intermediate parts fixed to the slide covers and wound around the pair of vertically fixed rollers for converting the rotational motion of the rotary pulley into sliding motion of the gripping finger fixed slide members.

According to an aspect of the present invention, to solve the problem of accurate determination of the opening and closing conditions of the gripping fingers, the gripping finger fixed slide member may have an opening and closing position detection member and the gripping device further comprises an open position detection sensor for detecting the opening and closing position detection member when the gripping finger fixed slide member is in an open position and a closed position detection sensor for detecting the opening and closing position detection member when the gripping finger fixed slide member is a closed position.

According to an aspect of the present invention, to solve the problem of detecting the displacement of the gripping finger, enabling quality control and grasping of gripping conditions, the gripping device may further comprise a displacement detection mechanism provided on the gripping finger fixed slide member for detecting displacement in a sliding direction.

According to an aspect of the present invention, to solve the problem of shortening the cycle time of assembling work and preventing the occurrence of assembling failure, the gripping device may further comprise a plurality of locking pins slid in the vertical direction between a locking position projecting downward from the lower surface of the upper structure and an unlocking position retreated inside the upper structure, a locking actuator projecting the plurality of lock pins to the locking position while the assembling machine carries the object gripped by the gripping fingers to a press-fitting position and retreating the plurality of locking pins to the unlocking position when the assembling machine press-fits the object gripped by the gripping finger into the fitting hole.

According to an aspect of the present invention, to solve the problem of automatically detecting excessive press-fitting reaction force, the gripping device may further comprise a load detection part sandwiched between a pair of through holes penetrating a peripheral edge part of the upper structure in the vertical direction and a strain gauge fixed to an inner wall surface of the through hole, wherein a step surface with an interval equal to or less than the elastically deformable length of the load detection part is provided on the upper surface of the upper structure.

According to an aspect of the present invention, to solve the problem of preventing foreign matter such as dust from entering the gripping device, the gripping device may further comprise a foreign matter intrusion preventing side cover formed in a cylindrical and bellows shape and surrounding the space between the upper structure and the lower structure.

According to an aspect of the present invention, to solve the problem of preventing foreign matter such as dust from entering the gripping device, the gripping device may further comprise a bellows-like foreign matter intrusion preventing bottom cover fixed to approximately the center of the support cover and having a locking claw locked to a base end part of the slide part for closing gap between the slide part and the sliding through groove.

In order to achieve the above object, the present invention provides an assembling machine equipped with the gripping device according to any one of the above aspects.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 shows a perspective view of an assembling machine equipped with a gripping device according to an embodiment of the present invention,

FIG. 2 shows (a) a plan view, (b) a front view and (c) an A-A line cross section view in FIG. 2(a) of the first embodiment of the gripping device according the present invention,

FIG. 3 shows partial cross section views and bottom views in (a) a closed state of the gripping fingers and (b) an open state of the gripping fingers according to the first embodiment,

FIG. 4 shows an exploded view of the gripping device according to the first embodiment,

FIG. 5 shows (a) a perspective view, (b) a plan view, and (c) an A-A line cross section view in FIG. 5(b) of a gripping finger fixed slide member according the second embodiment,

FIG. 6 shows a partially cut perspective view of a gripping finger opening and closing mechanism according to the second embodiment,

FIG. 7 shows a perspective view of radial arm members according to the second embodiment,

FIG. 8 shows partial cross section views and bottom views in (a) the closed state of the gripping fingers and (b) the open state of the gripping fingers according to the second embodiment,

FIG. 9 shows a partially cut perspective view of a variant of the second embodiment,

FIG. 10 shows a perspective view of a gripping finger fixed slide member according the variant of the second embodiment,

FIG. 11 shows partial cross section views and bottom views in (a) the closed state of the gripping fingers and (b) the open state of the gripping fingers according to the variant of the second embodiment,

FIG. 12 shows (a) a perspective view and (b) a partially cut perspective view of the gripping device according to the third embodiment,

FIG. 13 shows a partially cut perspective view of a part of the gripping finger opening and closing mechanism according to the third embodiment,

FIG. 14 shows partially cut plan views and partial cross section views in (a) the closed state of the gripping fingers and (b) the open state of the gripping fingers according to the third embodiment,

FIG. 15 shows (a) a perspective view, (b) a plan view with the upper structure removed and (c) a partially cut perspective view of the gripping device according to the fourth embodiment,

FIG. 16 shows (a) a partially cut perspective view and (b) exploded views of the gripping finger opening and closing mechanism according to the fourth embodiment,

FIG. 17 shows (a) a perspective view showing the interior and (b) a perspective view with the upper structure and the limiter removed of the gripping device according to the fifth embodiment,

FIG. 18 shows (a) a plan view with the upper structure removed and (b) a partially cut side view of the gripping device according to the fifth embodiment,

FIG. 19 shows (a) perspective views and (b) partially cut perspective views of a part of the gripping device according to the first variant embodiment,

FIG. 20 shows (a) a partially cut perspective view and (b) an exploded perspective view with a displacement detection mechanism of the gripping device and (c) a perspective view of the gripping finger fixed slide member with the displacement detection mechanism attached according to the second variant embodiment,

FIG. 21 shows partial cross section views of the gripping device in (a) a locking state and (b) an unlocking state of the lower structure according to the third variant embodiment,

FIG. 22 shows (a) a partially cross-sectioned front view of the gripping device mounted with a load cell mechanism, (b) a perspective view of the upper structure and (c) an expanded view of the area ‘A’ in (a) according to the fourth variant embodiment, and

FIG. 23 shows (a) a front view of the gripping device with a foreign matter intrusion preventing side cover attached, (b) a perspective view of the support cover with a foreign matter intrusion preventing bottom cover attached, and (c) a bottom view of the gripping device with the foreign matter intrusion preventing bottom cover attached according to the fifth variant embodiment.

### DETAILED DESCRIPTION OF THE INVENTION

Hereafter, the embodiments of the gripping device and assembling machine equipped with the gripping device are explained with reference to the drawings.

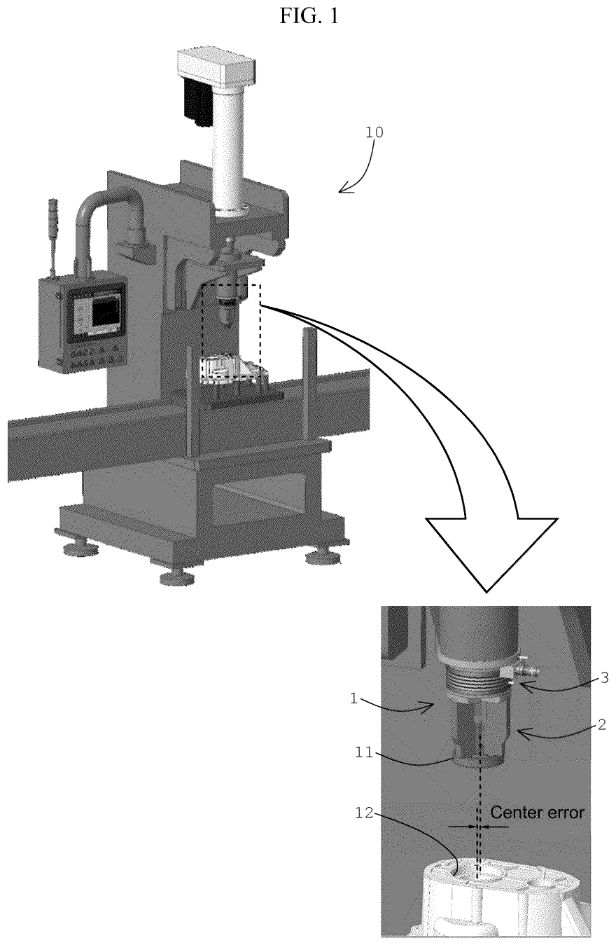

The gripping device 1 is attached to an assembling machine 10 as shown in FIG. 1, and press-fitted into a predetermined fitting hole 12 while gripping an object 11. The gripping device 1 mainly has a gripping finger opening and closing mechanism 2 for opening and closing a plurality of gripping fingers 21 for gripping the object 11, and a center error correcting mechanism 3 for correcting a center position when pressing the object 11 into the fitting hole 12. The following is an explanation of each configuration.

In addition, as the assembling machine 10, all assembling machines 10 capable of press fitting work such as a press fitting dedicated machine using a servo press, an industrial robot hand and etc. are included. In the following embodiment, a bearing is used as the object 11, but it is not limited to this, provided that the object 11 can be press-fitted into a predetermined fitting hole 12.

### 1st Embodiment

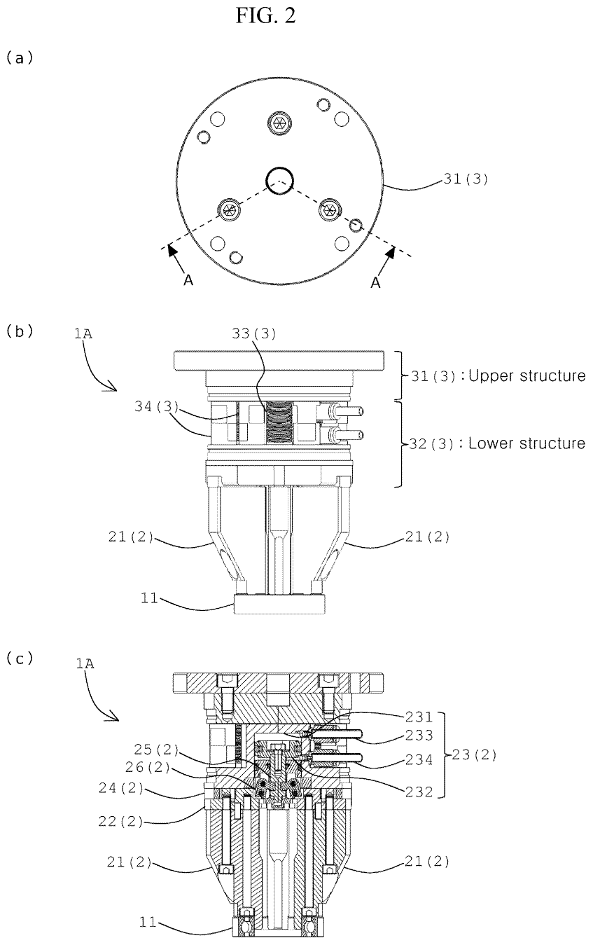

FIGS. 2(a)-(c) show the gripping device 1A of the first embodiment of the present invention. In this first embodiment, the center error correcting mechanism 3 includes an upper structure 31 fixed to the assembling machine 10, a lower structure 32 provided rockably to the upper structure 31 through a plurality of elastic bodies 33, and a limiter 34 provided between the upper structure 31 and the lower structure 32.

In this configuration, an ESP (Elastomer Shear Pad) or the like formed by alternately laminating disk-like rubber plates and metal washers is used as the elastic body 33. Further, the limiter 34 is formed of a rigid material having high load bearing capacity and limits press-fitting force acting on the elastic body 33 during center position correction or press-fitting when pressing the object 11 into the fitting hole 12. Although the limiter 34 can limit not only the press-fitting direction but also forces applied in the tensile direction, horizontal direction, twisting direction and inclination direction, it will do if it limits at least the press-fitting force.

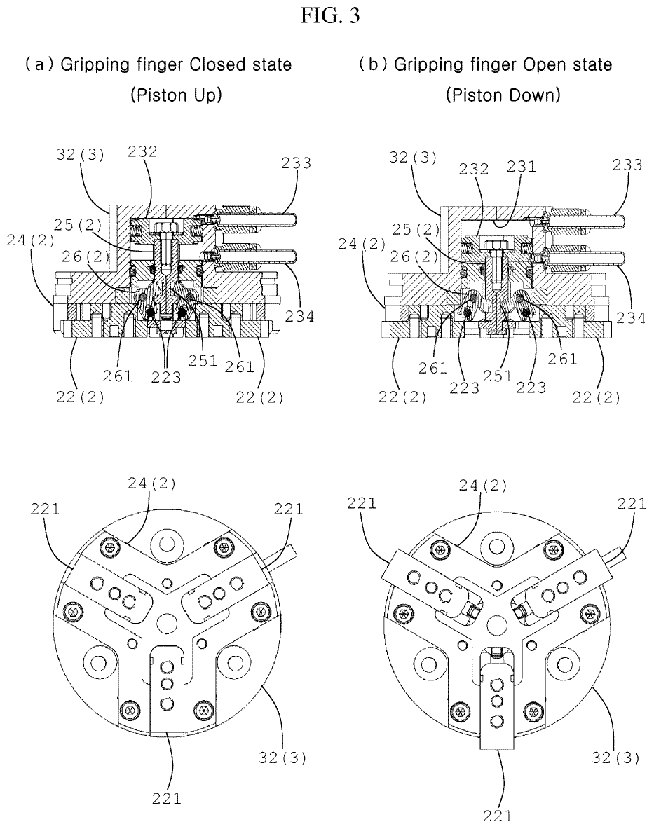

As shown in FIGS. 2 and 3, the gripping finger opening and closing mechanism 2 includes a plurality of gripping finger fixed slide members 22 which are provided radially to the center of the lower structure 32 and detachably fix each gripping finger 21, and an actuator 23 for sliding the gripping finger fixed slide member 22 radially in accordance with the size of the object 11.

In this first embodiment, as shown in FIG. 3, the actuator 23 has a piston member 232 moving up and down in an air cylinder 231, and an upper port 233 and a lower port 234 supplying compressed air into the air cylinder 231. As shown in FIG. 3(a), when compressed air is supplied to the lower port 234, the piston member 232 moves back upwardly, while as shown in FIG. 3(b), when compressed air is supplied to the upper port 233, the piston member 232 moves forward downwardly. In addition, the actuator 23 is not limited to this configuration and may be a linear actuator such as a solenoid.

Also, in this first embodiment, the gripping finger fixed slide member 22 has a gripping finger fixing part 221 for fixing the gripping finger 21 and a slide part 222 having a wider width than the gripping finger fixing part 221. In addition, the gripping finger fixing part 221 is constituted so that various types of gripping fingers 21 can be detachably attached by a long bolt or the like in accordance with the size and shape of the object 11 to be press-fitted.

Also, in this first embodiment, the gripping finger opening and closing mechanism 2 has a support cover 24 for supporting the gripping finger fixed slide member 22, a driving rod 25 vertically moved by the actuator 23, and an L-shaped link member 26 approximately formed in L-shape.

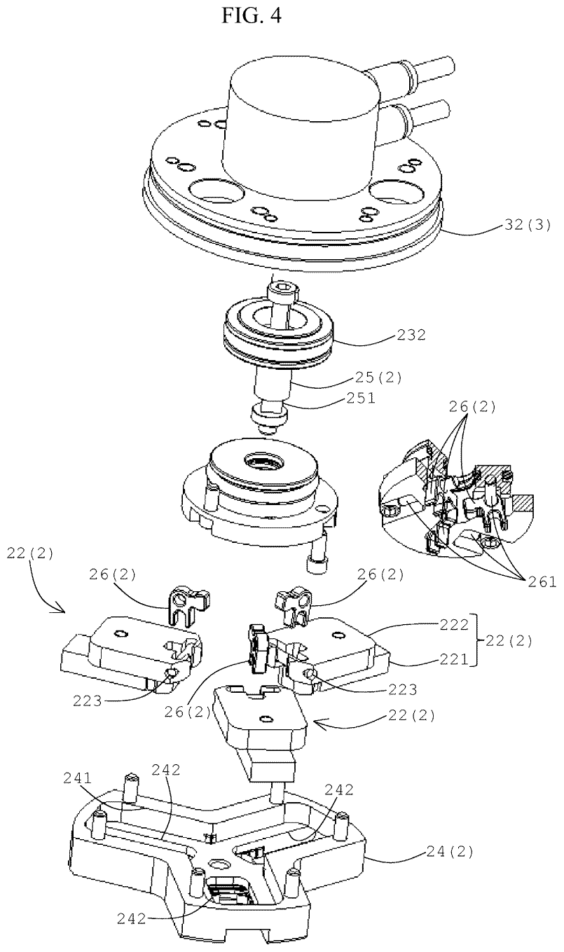

The support cover 24 is fixed to the lower structure 32 as shown in FIG. 3 and FIG. 4 and has a sliding fitting groove 241 for slidably fitting the slide part 222 and a sliding through groove 242 for slidably receiving the gripping finger fixing part 221. Further, the upper end part of the driving rod 25 is fixed to the piston member 232, and a recessed groove 251 for hooking one end of the L-shaped link member 26 to link it is formed along a circumferential direction at the lower end part.

Furthermore, as shown in FIG. 3, the L-shaped link member 26 is linked by fitting one end into the recessed groove 251 of the driving rod 25, and the other end is linked to a hinge pin 223 provided in the gripping finger fixed slide member 22. The L-shaped link member 26 is rotated around a rotation shaft 261 provided in an approximately horizontal direction in the lower structure 32 to convert vertical motion of the driving rod 25 into slide motion of the gripping finger fixed slide member 22.

In more detail, as shown in FIG. 3(a), one end of the L-shaped link member 26 is lifted up when the driving rod 25 integrated with the piston member 232 moves upward. Consequently, since the L-shaped link member 26 rotates around the rotation shaft 261 and the other end draws the hinge pin 223 toward a central direction, the gripping finger fixed slide member 22 slides inward along a radial direction. Consequently, each gripping finger 21 fixed to each of the gripping finger fixed slide members 22 is brought into a closed state.

On the other hand, as shown in FIG. 3(b), when the driving rod 25 integrated with a piston member 232 moves downward, one end of an L-shaped link member 26 is pushed down. Consequently, the L-shaped link member 26 rotates around the rotation shaft 261, and the other end pushes out the hinge pin 223 outward, so that the gripping finger fixed slide member 22 slides outward along the radial direction. Consequently, each gripping finger 21 fixed to each of the gripping finger fixed slide members 22 is opened. In FIG. 3, the figure is shown with the gripping finger 21 removed.

Hereinafter, the actions of the gripping device 1A of this first embodiment and the assembly machine 10 equipped with it are explained.

First, when the object 11 is press-fitted into the predetermined fitting hole 12 by using the gripping device 1A of this first embodiment, the actuator 23 slides and moves the gripping finger fixed slide member 22 radially in accordance with the size of the object 11. Consequently, since each of the gripping fingers 21 is opened and closed to a desired size, various objects 11 can be held.

For example, as shown in FIG. 2, when the inner ring of a bearing is to be gripped by the gripping finger 21, the tip of the gripping finger 21 is inserted into the inner ring in its closed state inward from the inner diameter of the inner ring, and then the gripping finger 21 is spread outward to grip the inner ring of the bearing. In the case of gripping an outer ring of the bearing by the gripping finger 21, the tip of the gripping finger 21 is arranged outside the outer ring in a state that it is spread outward from the outer diameter of the outer ring, and then the gripping finger 21 is closed inward to grip the outer ring of the bearing.

The object 11 gripped by the gripping finger 21 is conveyed to an upper position of a predetermined fitting hole 12 by the assembling machine 10, and then is moved downward to be pressed in. At this time, when there is a center error (core deviation) between the center axis of the object 11 and the center axis of the fitting hole 12 as shown in FIG. 1, an end edge part of its lower surface contacts a chamfered part provided on an edge of the fitting hole 12, and reaction force acts on the contacting part.

Consequently, the center error correcting mechanism 3 horizontally moves the object 11 along the chamfered part of the fitting hole 12, and automatically matches the center axis of the object 11 with the center axis of the fitting hole 12. Accordingly, even if there is a center error or inclination between the components, the object 11 is smoothly pressed into the fitting hole 12. Consequently, generation of excessive press-in force caused by the center error and inclination is prevented, so that damage to the object 11 and parts on the fitting hole 12 side or adverse effect on the assembling machine 10 can be suppressed.

Further, when the object 11 is pressed into the fitting hole 12, press-fitting force acting on the plurality of gripping fingers 21 acts on the assembly machine 10 through the gripping finger fixed slide member 22, the lower structure 32, the elastic body 33, the limiter 34 and the upper structure 31. Consequently, since the gripping finger opening and closing mechanism 2 and the center error correcting mechanism 3 are not damaged by high load at press fitting, a function for gripping various objects 11 and a function for correcting center positions at press fitting holes 12 are integrated.

In this first embodiment, the air cylinder 231, the piston member 232 and the driving rod 25 as the actuator 23 constituting the gripping finger opening and closing mechanism 2 are provided inside the lower structure 32. Consequently, the device is compactly assembled as a whole, and rigidity and stability are not reduced.

According to the gripping device 1A of this first embodiment and the assembling machine 10 provided with the gripping device 1A, the following effects are achieved.

1. A function for gripping various objects 11 and a function for correcting a center position when the object 11 is pressed into the fitting hole 12 can be integrated without lowering rigidity and stability as a whole.

2. As it is not necessary to prepare a special gripping tool for each object 11, costs related to design and manufacture can be reduced.

3. As it is not necessary to perform the replacement work of the gripping tool, a work load applied to an operator can be reduced and productivity can be improved.

### 2nd Embodiment

Hereinafter, the gripping device 1B of the second embodiment of the present invention is explained. In addition, in the configuration of this second embodiment, the same numbers are assigned to the elements which are identical or equivalent to those in the above first embodiment, and the repeated explanation will be omitted.

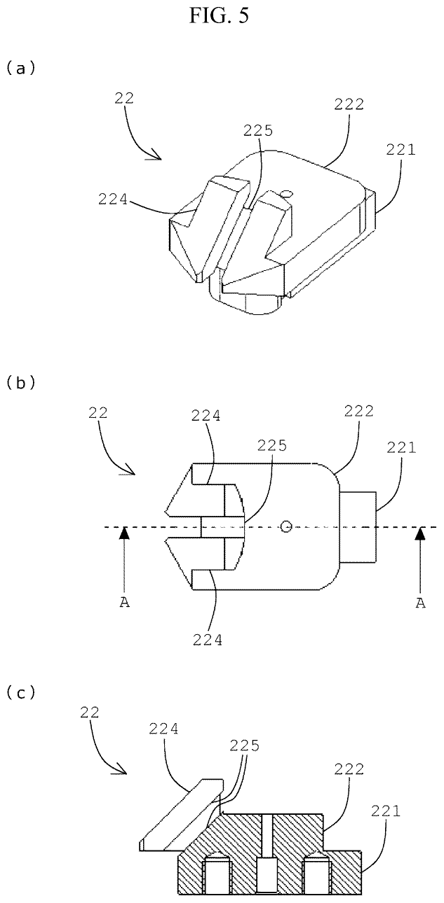

The feature of this second embodiment is that the gripping finger opening and closing mechanism 2 simplifies the configuration without using the L-shaped link member 26. In detail, as shown in FIG. 5, the gripping finger fixed slide member 22 has a gripping finger fixing part 221 and a sliding part 222. At the base end of the slide part 222, an inclined guide surface 224 inclined at a predetermined inclination angle and a T-shaped inclination groove 225 having an inclined surface parallel to the inclined guide surface 224 and formed into a substantially T-shaped cross section are provided.

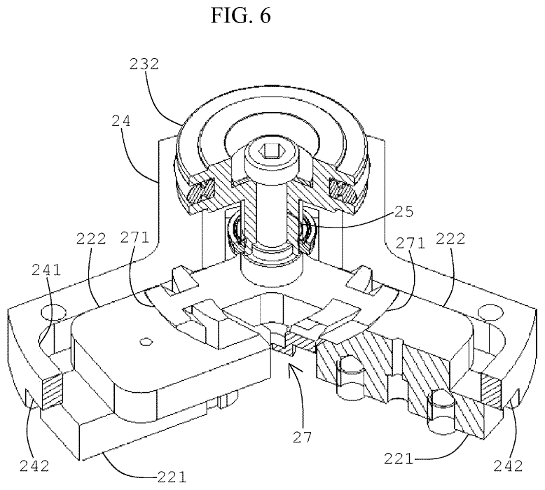

In this second embodiment, as shown in FIG. 6, the gripping finger opening and closing mechanism 2 has a support cover 24 fixed to the lower structure 32 and a radial arm member 27 vertically moved by the actuator 23.

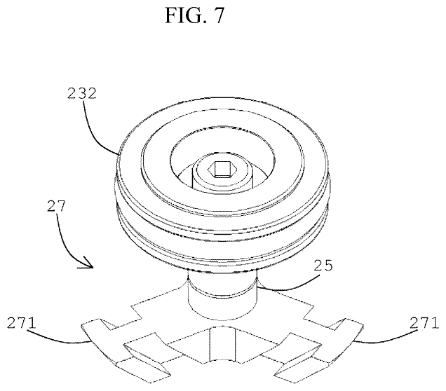

The radial arm member 27 is fixed to the piston member 232 via the driving rod 25 as shown in FIG. 6 and FIG. 7 and radially extended toward each of the gripping finger fixed slide members 22. At each tip of each radial arm member 27, a T-shaped inclined piece 271 formed in a substantially T-shaped cross section having an inclined plane parallel to the inclined plane of the inclined guide surface 224 and the T-shaped inclined groove 225 is provided. By sliding the T-shaped inclined piece 271 along the inclined guide surface 224 and the T-shaped inclined groove 225 of the gripping finger fixed slide member 22, vertical motion of the radial arm member 27 is converted into a slide motion of the gripping finger fixed slide member 22.

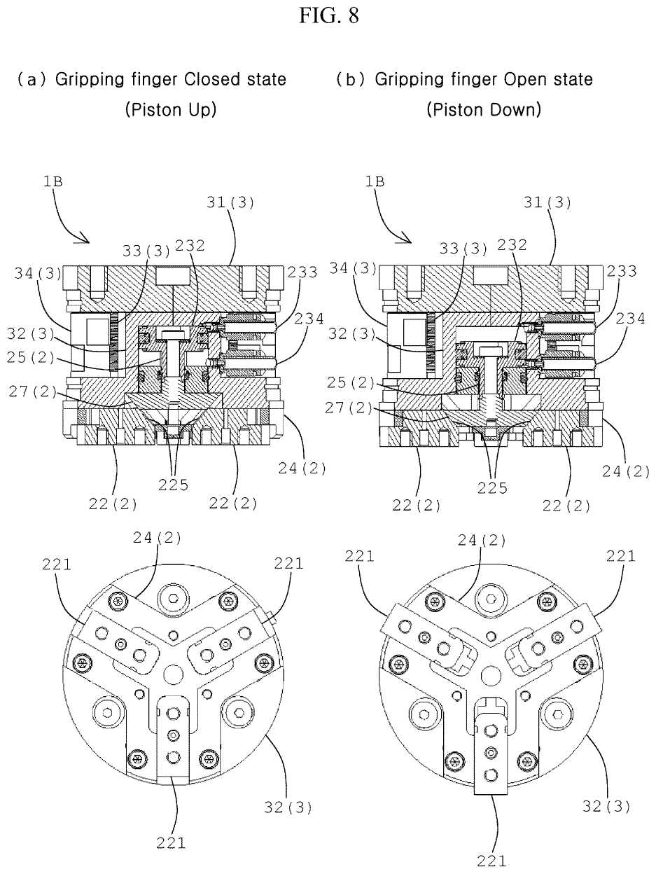

In more detail, as shown in FIG. 8(a), when the driving rod 25 integrated with the piston member 232 moves upward, the radial arm member 27 is lifted up. Consequently, the inner surface of the T-shaped inclined piece 271 slides upward while applying inclined upward pressing force to the inner surface of the T-shaped inclined groove 225 and draws the gripping finger fixed slide member 22 toward the central direction. Accordingly, since the gripping finger fixed slide member 22 slides inward in the radial direction in the support cover 24, each gripping finger 21 fixed to each of the gripping finger fixed slide members 22 is closed.

On the other hand, as shown in FIG. 8(b), when the driving rod 25 integrated with the piston member 232 moves downward, the radial arm member 27 is pushed down. Consequently, the outer faces of the inclined guide surface 224 and the T-shaped inclined piece 271 slide downward while applying inclined downward pressing force to the outer face of the T-shaped inclined groove 225 to push out the gripping finger fixed slide member 22 outward. Accordingly, since the gripping finger fixed slide member 22 slides outward in the radial direction in the support cover 24, each gripping finger 21 fixed to each of the gripping finger fixed slide members 22 is opened. In FIG. 8, the figure is shown with the gripping finger 21 removed.

The gripping device 1B of the second embodiment and the assembling machine 10 provided with the gripping device 1B have the same effect as that of the first embodiment. Further, since the configuration is simplified compared with the first embodiment, the number of components can be reduced.

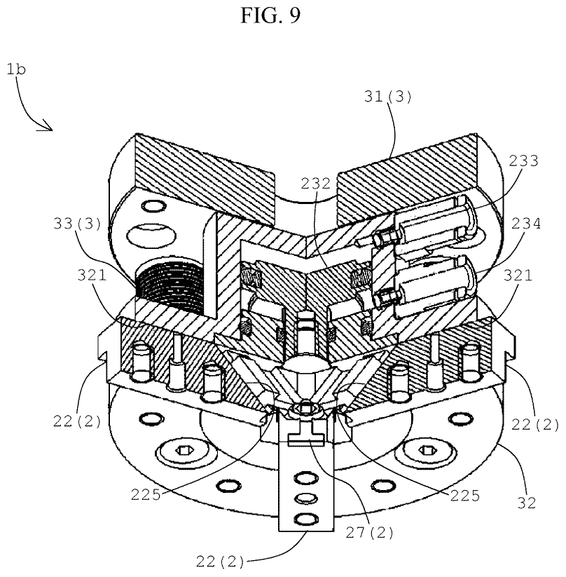

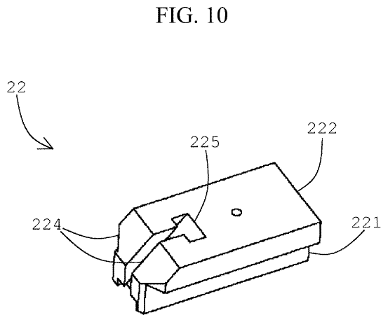

Next, the gripping device 1b related to a variant example without using the support cover 24 in the configuration of the second embodiment is shown in FIG. 9. In this variant example, the gripping finger fixed slide member 22 has a gripping finger fixing part 221 and a sliding part 222 as shown in FIG. 10. At the base end of the slide part 222, the inclined guide surface 224 inclined at a predetermined inclination angle and a T-shaped inclined groove 225 having an inclined surface parallel to the inclined guide surface 224 and formed into a substantially T-shaped cross section are provided.

In this variant example, the gripping finger opening and closing mechanism 2 is provided on the lower structure 32 as shown in FIG. 9 and has a T-shaped slot 321 having an approximately T-shaped cross section for slidably fitting the gripping finger fixed slide member 22 and a radial arm member 27 moved vertically by the actuator 23.

By the above constitution, a T-shaped inclined piece 271 provided at each tip of the radial arm member 27 slides along the inclined guide surface 224 and the T-shaped inclined groove 225, so that vertical motion of the radial arm member 27 is converted into slide motion of a gripping finger fixed slide member 22.

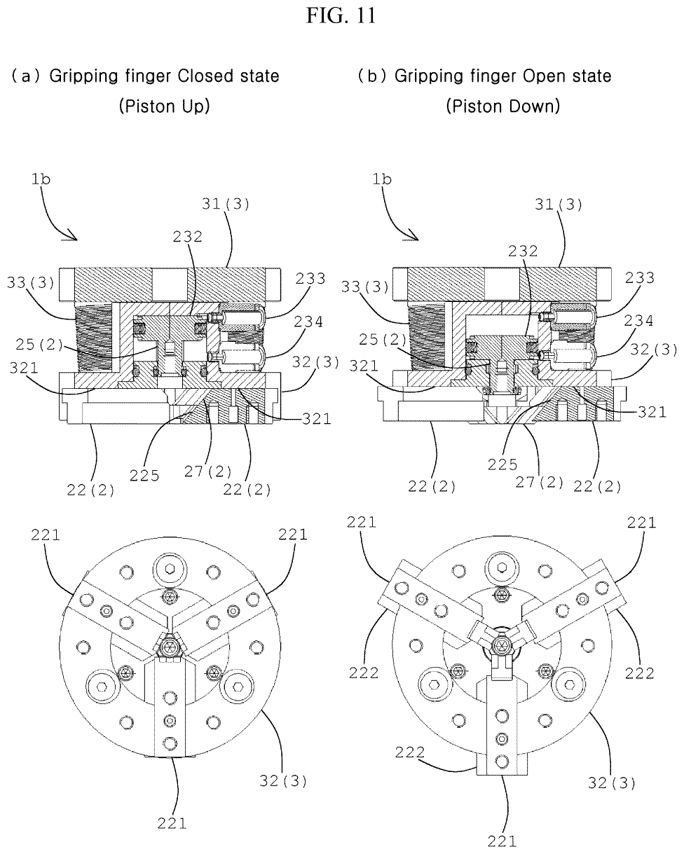

In detail, as shown in FIG. 11(a), when the driving rod 25 integrated with the piston member 232 moves upward, the radial arm member 27 is lifted up. Consequently, the inner surface of the T-shaped inclined piece 271 slides upward while applying inclined upward pressing force to the inner surface of the T-shaped inclined groove 225 and draws the gripping finger fixed slide member 22 toward the central direction. As a result, the gripping finger fixed slide member 22 slides inward in the radial direction along the T-shaped slot 321, so that each gripping finger 21 fixed to each of the gripping finger fixed slide members 22 is closed.

On the other hand, as shown in FIG. 11(b), when the driving rod 25 integrated with the piston member 232 moves downward, the radial arm member 27 is pushed down. Consequently, the outer faces of the inclined guide surface 224 and the T-shaped inclined piece 271 slide downward while applying inclined downward pressing force to the outer face of the T-shaped inclined groove 225 to push out the gripping finger fixed slide member 22 outward. As a result, the gripping finger fixed slide member 22 slides outward in the radial direction along the T-shaped slot 321, so that each gripping finger 21 fixed to each of the gripping finger fixed slide members 22 is opened. In FIG. 11, the figure is shown with the gripping finger 21 removed.

As mentioned before, the gripping device 1b according to this variant example of the second embodiment and the assembling machine 10 provided with the same have the same effect as the first embodiment and the second embodiment described above. Furthermore, since the configuration is simplified compared with the second embodiment, the number of components can be further reduced.

### 3rd Embodiment

Hereinafter, the gripping device 1C of the third embodiment of the present invention is explained. In addition, in the configuration of this third embodiment, the same numbers are assigned to the elements which are identical or equivalent to those in the above embodiments, and the repeated explanation will be omitted.

The characteristic of the third embodiment is that a driving wire 28 is used instead of the L-shaped link member 26 and the radial arm member 27 in the gripping finger opening and closing mechanism 2. Also, an air cylinder 231 is adopted as the actuator 23, but it is not limited to this configuration, and a solenoid or the like can be similarly adopted as a linear driving source.

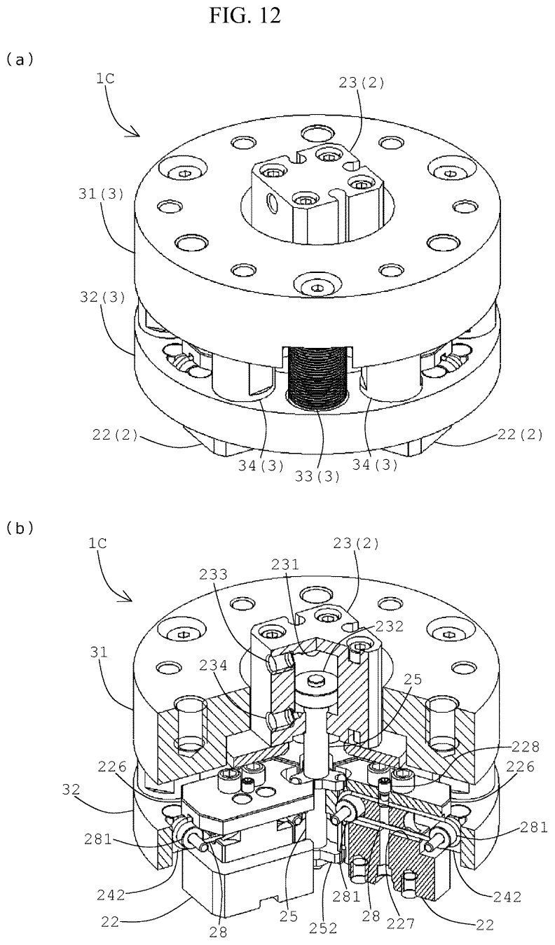

In detail, the lower structure 32 is provided with the air cylinder 231 as the actuator 23 in the downward direction as shown in FIG. 12, and the driving rod 25 expands and contracts in the vertical direction. Also, the gripping finger opening and closing mechanism 2 is provided in the lower structure 32 and has a sliding through groove 242 for slidably penetrating the gripping finger fixed slide member 22, and a slide cover 226 fixed to the upper surface of the gripping finger fixed slide member 22.

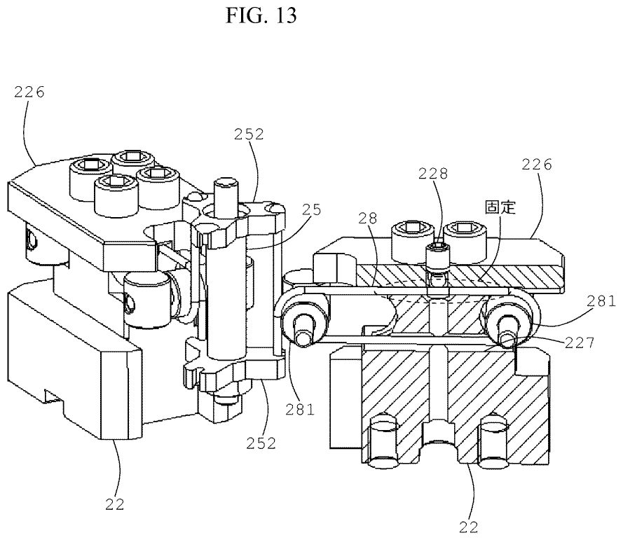

Furthermore, as shown in FIG. 12 and FIG. 13, the gripping finger opening and closing mechanism 2 has the driving rod 25 vertically moved by the actuator 23, a pair of wire hooks 252 fixed to the upper and the lower positions of the driving rod 25, and a pair of horizontally fixed rollers 281 rotatably supported around a rotation axis in an approximately horizontal direction at both ends of the sliding through groove 242, and a driving wire 28 having one end and the other end fixed to each of the wire hooks 252.

The driving wire 28 is made of a non-stretchable material and moves integrally by tightening and fixing an upper intermediate part thereof between the slide cover 226 and the gripping finger fixed slide member 22 as shown in FIG. 13. On the other hand, a lower intermediate part is inserted so as not to interfere with a through hole 227 provided in the gripping finger fixed slide member 22. The driving wire 28 is wound around a pair of the horizontally fixed rollers 281, thereby converting the vertical motion of the driving rod 25 into the sliding motion of the gripping finger fixed slide member 22.

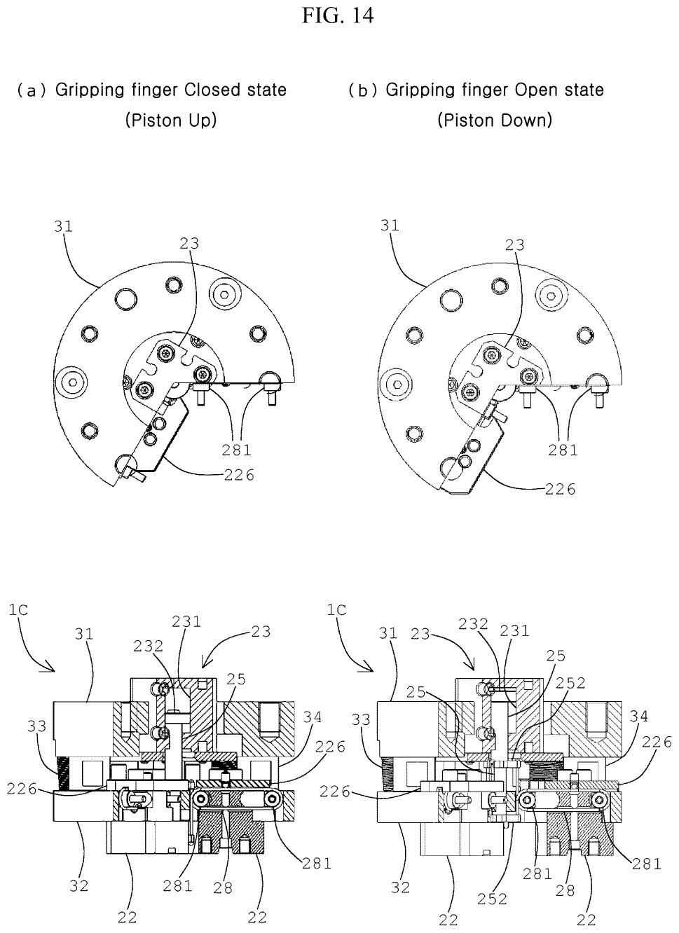

In detail, as shown in FIG. 14(a), when the driving rod 25 is moved downward by the air cylinder 231, the lower wire hook 252 pulls down one end of the driving wire 28 to generate tension. Consequently, the driving wire 28 moves around the horizontally fixed roller 281 and pulls the gripping finger fixed slide member 22 toward the central direction. As a result, since the gripping finger fixed slide member 22 slides inward in the radial direction along the sliding through groove 242, each gripping finger 21 fixed to each of the gripping finger fixed slide members 22 is closed.

On the other hand, as shown in FIG. 14(b), when the driving rod 25 is moved upward by the air cylinder 231, the upper wire hook 252 pulls the other end of the driving wire 28 upward to generate tension. Consequently, the driving wire 28 moves around the horizontally fixed roller 281 and pushes out the gripping finger fixed slide member 22 outward. As a result, since the gripping finger fixed slide member 22 slides outward in the radial direction along the sliding through groove 242, each gripping finger 21 fixed to each of the gripping finger fixed slide members 22 is opened. In FIG. 14, the figure is shown with the gripping finger 21 removed.

In addition, in this third embodiment, a tension adjusting screw 228 is provided to thread through the slide cover 226 as shown in FIG. 13. If the tension of the driving wire 28 is insufficient, the tension adjusting screw 228 is screwed so as to project from the lower surface of the slide cover 226. As a result, the tension adjusting screw 228 pushes the driving wire 28 downward to increase tension.

The gripping device 1C of the third embodiment and the assembling machine 10 provided with the gripping device 1C have the same effect as that of the first embodiment. Furthermore, since complicated machine working such as the T-shaped inclined groove 225 and the T-shaped inclined piece 271 is not required compared to the second embodiment, the production can be made simply and inexpensively. Furthermore, since the dimensions in the press fitting direction are compacted, rigidity and stability as a whole of the device can be enhanced.

### 4th Embodiment

Hereinafter, the gripping device 1D of the fourth embodiment of the present invention is explained. In addition, in the configuration of this fourth embodiment, the same numbers are assigned to the elements which are identical or equivalent to those in the above embodiments, and the repeated explanation will be omitted.

The characteristic of the fourth embodiment is that a rotary actuator such as a motor 237 or a pneumatic rotary cylinder is used instead of the linear actuator such as the air cylinder 231 or the solenoid and the gripping finger 21 is opened and closed by rotating motion of the rotary actuator.

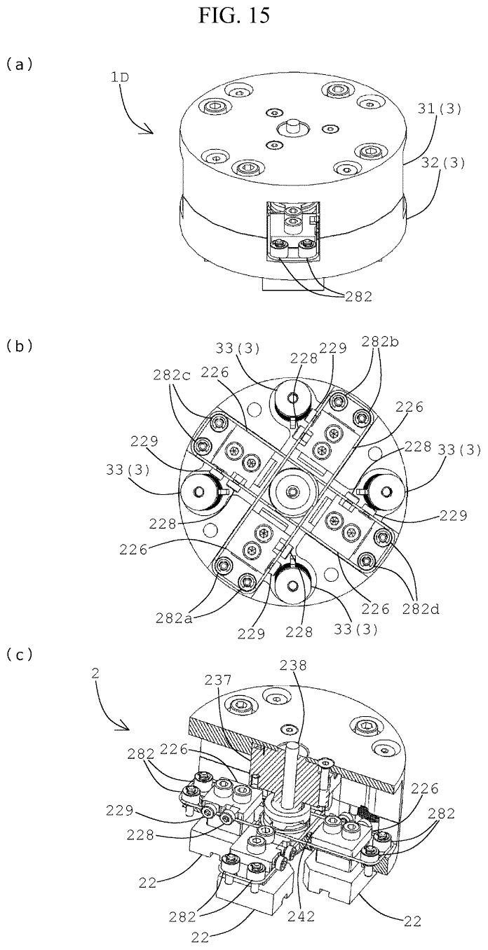

In detail, as shown in FIG. 15, the motor 237 as the actuator 23 is fixed to the upper structure 31 and the driving shaft 238 projecting downward is rotated. The gripping finger opening and closing mechanism 2 has in the lower structure 32 a sliding through groove 242 slidably penetrating four gripping finger fixed slide members 22 provided at equal angular intervals of 90 degrees with respect to the drive shaft 238, and a slide cover 226 fixed to the upper surface of each gripping finger fixed slide member 22 that is penetrated by the sliding through groove 242.

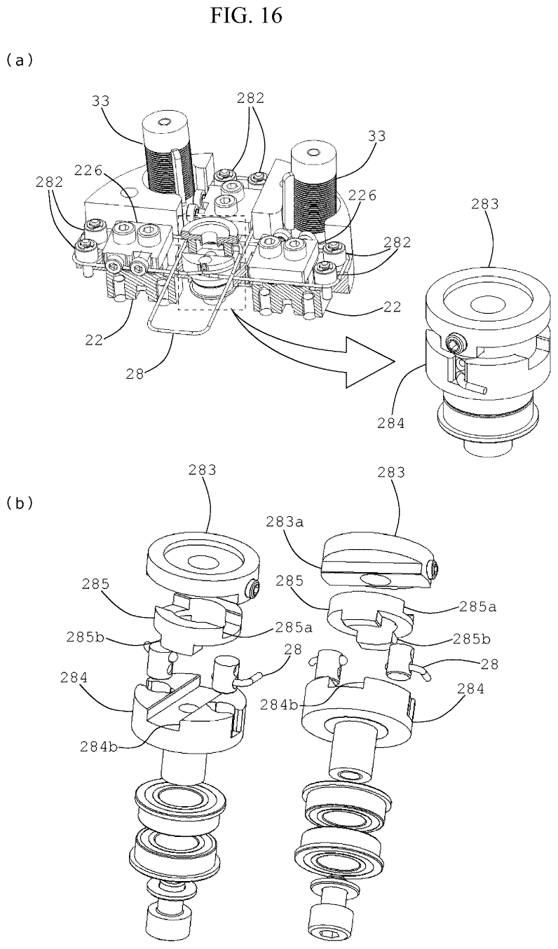

Furthermore, as shown in FIG. 15 and FIG. 16, the gripping finger opening and closing mechanism 2 has a pair of vertically fixed rollers 282 arranged outside in the sliding direction of the sliding through groove 242 and rotatably supported around a rotation axis in an approximately vertical direction, a driving pulley 283 connected to the driving shaft 238 of the motor 237 and rotated around the driving shaft 238 in an approximately vertical direction, a driven pulley 284 provided in the lower structure 32 to rotate in conjunction with the driving pulley 283, an intermediate pulley 285 provided between the driving pulley 283 and the driven pulley 284 to slidably connect the driven pulley 284 to the driving pulley 283 along two directions orthogonal to each other, and a driving wire 28 having one end and the other end fixed to the driven pulley 284.

In this fourth embodiment, as shown in FIG. 16(b), on the upper and lower surfaces of the intermediate pulley 285, a recessed groove 285a for slidably fitting a projecting part 283a provided on the lower surface of the driving pulley 283 and a projecting part 285b slidably fitted in a recessed groove 284b provided on the upper surface of the driven pulley 284 are provided at right angles to each other. Consequently, even if the lower structure 32 swings when correcting the center error, the intermediate pulley 285 slide along two directions orthogonal to each other to maintain a connection state between the driving pulley 283 and the driven pulley 284. As a result, the rotation of the driving shaft 238 is surely transmitted even if the center axes of the driving pulley 283 and the driven pulley 284 are deviated.

In addition, the relation between the projecting part and the recessed groove provided in each of the driving pulley 283, the driven pulley 284 and the intermediate pulley 285 may be provided opposite to the above configuration as long as they are fitted and slid on one side and the other side facing each other.

Also, in this fourth embodiment, the driving wire 28 is made of a piece of non-stretchable material. Also, as shown in FIG. 15(b), the driving wire 28 starts from one end fixed to the driven pulley 284 and is wound in the following order, and the other end is fixed to the driven pulley 284:
a vertically fixed roller 282a arranged outside the first gripping finger fixed slide member 22,
a vertically fixed roller 282b arranged outside the second gripping finger fixed slide member 22,
a vertically fixed roller 282c arranged outside the third gripping finger fixed slide member 22,
a vertically fixed roller 282d arranged outside the fourth gripping finger fixed slide member 22.

As shown in FIG. 15(b), the middle part of the driving wire 28 is fastened and fixed by a fixing screw 229 provided on the side face of each slide cover 226, so that all the gripping finger fixed slide members 22 move integrally with the driving wire 28. As mentioned above, the driving wire 28 converts the rotational motion of the driven pulley 284 into the sliding motion of the gripping finger fixed slide members 22.

In more detail, when the driving pulley 283 connected to the driving shaft 238 of the motor 237 is rotated counterclockwise, the driven pulley 284 pulls one end of the driving wire 28 to generate tension. Consequently, the driving wire 28 moves counterclockwise along the vertically fixed roller 282 and pulls the gripping finger fixed slide members 22 toward the central direction. As a result, since the gripping finger fixed slide members 22 slide inward in the radial direction along the sliding through groove 242, each gripping finger 21 fixed to each of the gripping finger fixed slide members 22 is closed.

On the other hand, when the driving pulley 283 connected to the driving shaft 238 of the motor 237 is rotated clockwise, the driven pulley 284 pulls the other end of the driving wire 28 to generate tension. Consequently, the driving wire 28 moves clockwise along the vertically fixing roller 282 and pushes the gripping finger fixed slide members 22 outward in the radial direction. As a result, since the gripping finger fixed slide members 22 slide outward in the radial direction along the sliding through groove 242, each gripping finger 21 fixed to each of the gripping finger fixed slide members 22 is opened.

Although, in this fourth embodiment, all the gripping finger fixed slide members 22 are driven by one driving wire 28, the present invention is not limited to this configuration. That is, for example, two pairs of gripping finger fixed slide members 22 facing each other respectively may be driven by two driving wires 28.

Also, in this fourth embodiment, the tension adjusting screw 228 is provided on the side face of the slide cover 226 as shown in FIG. 15(b). If the tension of the driving wire 28 is insufficient, the tension adjusting screw 228 is tightened so as to be screwed into the slide cover 226. Consequently, the tension adjusting screw 228 pushes the driving wire 28 inward to increase tension.

The gripping device 1D of this fourth embodiment as described above and the assembling machine 10 provided with the gripping device 1D have the same effect as that of the first embodiment and the third embodiment. Further, by providing the intermediate pulley 285 between the driving pulley 283 and the driven pulley 284, rotary motion of the motor 237 can be transmitted without hindering oscillation while correcting center error.

### 5th Embodiment

Hereinafter, the gripping device 1E of the fifth embodiment of the present invention is explained. In addition, in the configuration of this fifth embodiment, the same numbers are assigned to the elements which are identical or equivalent to those in the above embodiments, and the repeated explanation will be omitted.

The characteristic of this fifth embodiment is that the rotary transmission mechanism comprising the driving pulley 283, the driven pulley 284 and the intermediate pulley 285 used in the fourth embodiment is not used by providing the actuator 23 onto the lower structure 32.

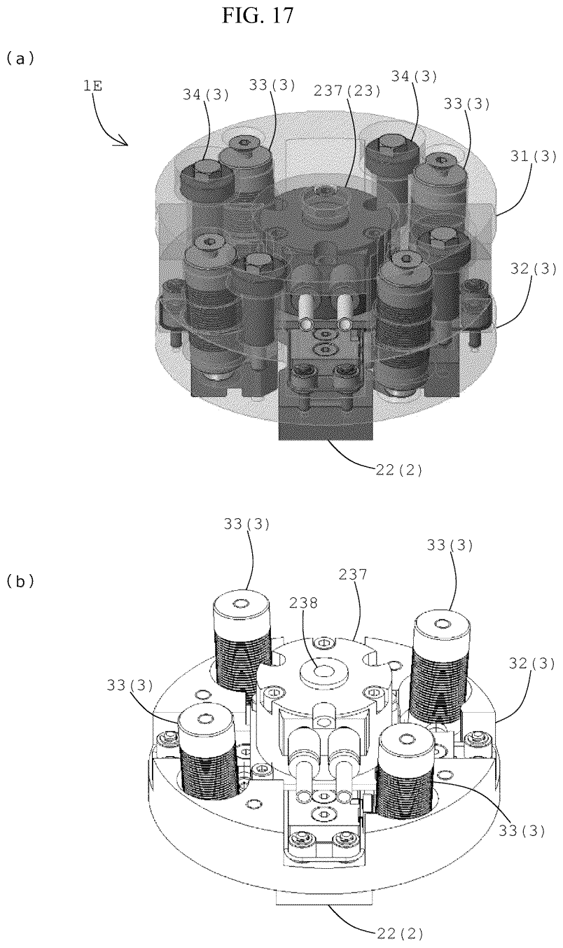

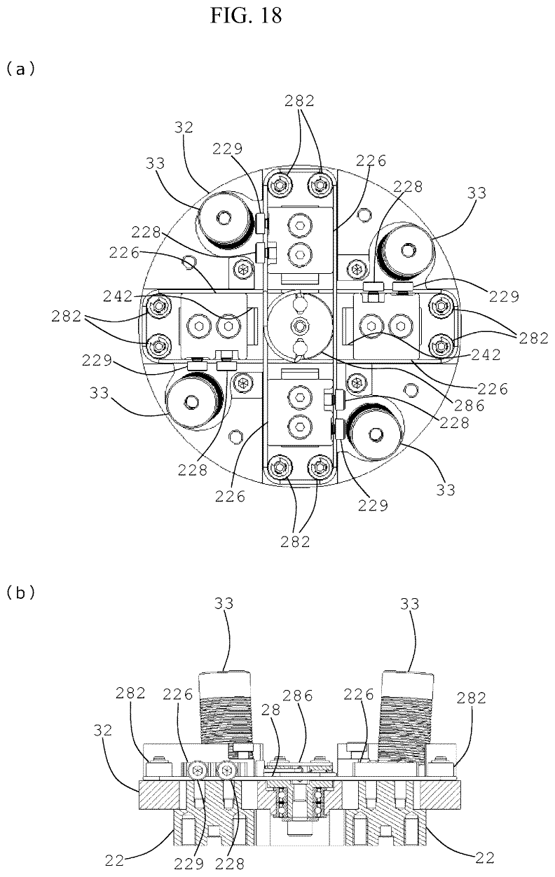

In detail, as shown in FIG. 17, a motor 237 as the actuator 23 is fixed to the lower structure 32 and a driving shaft 238 projected downward is rotated. Also, as shown in FIG. 18(b), the gripping finger opening and closing mechanism 2 has a sliding through groove 242 provided in a lower structure 32 for the gripping finger fixed slide member 22 to slidably penetrate, and a slide cover 226 fixed to the upper surface of the gripping finger fixed slide member 22 which penetrates into the sliding through groove 242.

In addition, as shown in FIG. 17 and FIG. 18, the gripping finger opening and closing mechanism 2 has a pair of vertically fixed rollers 282 arranged at an outer side in the sliding direction of the sliding through groove 242 and rotatably supported around rotating shafts in an approximately vertical direction, a rotary pulley 286 connected to the driving shaft 238 of the motor 237 and rotated around the driving shaft 238 in an approximately vertical direction, and a driving wire 28 having one end and the other end fixed to the rotary pulley 286.

In this fifth embodiment, the driving wire 28 is wound around the vertically fixed rollers 282 and fixed to the slide cover 226 in the same way as in the fourth embodiment. Consequently, the driving wire 28 converts the rotational motion of the rotary pulley 286 into the sliding motion of the gripping finger fixed slide member 22.

In detail, when the rotary pulley 286 connected to the driving shaft 238 of the motor 237 is rotated counterclockwise, tension is generated by pulling one end of the driving wire 28. Consequently, the driving wire 28 moves counterclockwise along the vertically fixed rollers 282 and pulls the gripping finger fixed slide member 22 toward the central direction. As a result, since the gripping finger fixed slide member 22 slides inward in the radial direction along the sliding through groove 242, each gripping finger 21 fixed to each of the gripping finger fixed slide members 22 is closed.

On the other hand, if the rotary pulley 286 connected to the driving shaft 238 of the motor 237 is rotated clockwise, tension is generated by pulling the other end of the driving wire 28. Consequently, the driving wire 28 moves clockwise along the vertically fixed rollers 282 and pushes the gripping finger fixed slide member 22 outward in the radial direction. As a result, since the gripping finger fixed slide member 22 slides outward in the radial direction along the sliding through groove 242, each gripping finger 21 fixed to each of the gripping finger fixed slide members 22 is opened.

The gripping device 1E of the fifth embodiment as described above and the assembling machine 10 provided with the gripping device 1E have the same effect as that of the first embodiment. Furthermore, the number of components can be reduced compared to the fourth embodiment, and manufacture can be made simply and inexpensively.

Hereinafter, options that can be arbitrarily added in the gripping device 1 according to the present invention is explained. In addition, among the following optional configurations, the same or equivalent configuration as that in each embodiment described above is marked with the same number and its repetitive explanation is omitted. In addition, although the following options explain the example applied to the first embodiment above, they can be applied to other embodiments as appropriate.

### (1) Option 1: Opening and Closing Detection Mechanism

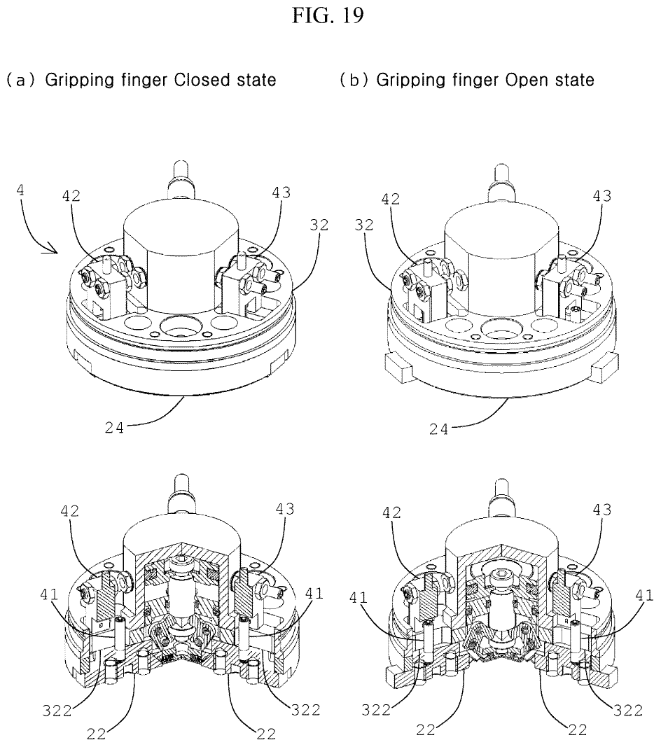

The option 1 is an opening and closing detection mechanism 4 capable of detecting whether the gripping finger 21 is in an open or closed state. In detail, an elongated hole 322 is formed in the lower structure 32 along the sliding direction of each gripping finger fixed slide member 22 as shown in FIG. 19(a), (b). On the other hand, a rod-shaped opening and closing position detecting member 41 is provided upward on the gripping finger fixed slide member 22 and projected from the elongated hole 322 of the lower structure 32.

In addition, an open position detection sensor 42 for detecting the opening and closing position detection member 41 when the gripping finger fixed slide member 22 is in an open position as shown in FIG. 19(a) and a closed position detection sensor 43 for detecting the opening and closing position detection member 41 when the gripping finger fixed slide member 22 is in a closed position as shown in FIG. 19(b) are provided so as to straddle the elongated hole 322.

Consequently, in an open state of the gripping finger 21, the open position detection sensor 42 detects the opening and closing position detection member 41 and the closed position detection sensor 43 does not detect the member 41. On the other hand, in a closed state of the gripping finger 21, the closed position detection sensor 43 detects the opening and closing position detection member 41, and the open position detection sensor 42 does not detect the member 41.

According to the opening and closing detection mechanism 4 of the option 1 as described above, the opening and closing state of the gripping finger 21 which is essential information for automatic operation is double checked by the open position detection sensor 42 and the closed position detection sensor 43, so that accurate determination can be achieved.

### (2) Option 2: Displacement Detection Mechanism

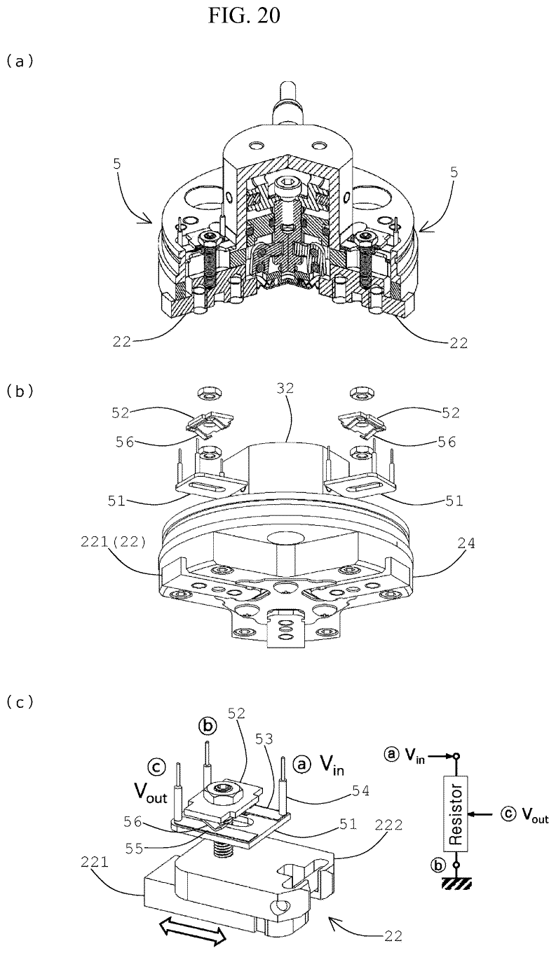

The option 2 is a displacement detection mechanism 5 capable of detecting the displacement amount of the gripping finger 21. In detail, the displacement detection mechanism 5 for detecting displacement in the sliding direction is provided on the gripping finger fixed slide member 22 as shown in FIGS. 20(a) to (c).

The displacement detection mechanism 5 comprises a lower substrate 51 fixed to the lower structure 32 and a wiper substrate 52 fixed to a bolt projecting upward from the gripping finger fixed slide member 22 as shown in FIGS. 20(a) to (c).

A resistor 53 having an input terminal 54 and an output terminal 55 are provided on the lower substrate 51 at right and left positions of the elongated hole 322 along a sliding direction. Also, a wiper board 52 is provided with a conductive wiper 56 sliding while abutting on the resistor 53 and the output terminal 55.

According to the displacement detection mechanism 5 of the option 2 as described above, the position of the wiper 56 in contact with the resistor 53 changes with the sliding movement of the gripping finger 21, so that a resistance value detected at the output terminal 55 changes. Consequently, the displacement amount of the gripping finger 21 can be detected based on the detected resistance value. Consequently, it is automatically determined whether or not the object 11 held by the gripping finger 21 has an appropriate size. As a result, it becomes possible to cope with a wide variety of objects 11 and to perform quality control. Furthermore, when the detected size is different from the size of the object 11, it is possible to read the detection as a gripping in an inclined state, etc.

In addition, the displacement detection mechanism 5 is not limited to the above configuration, provided that it can convert mechanical linear motion into an electric signal as a displacement amount such as a differential transformer (LVDT: Linear Variable Differential Transformer) or a linear encoder.

### (3) Option 3: Locking Mechanism

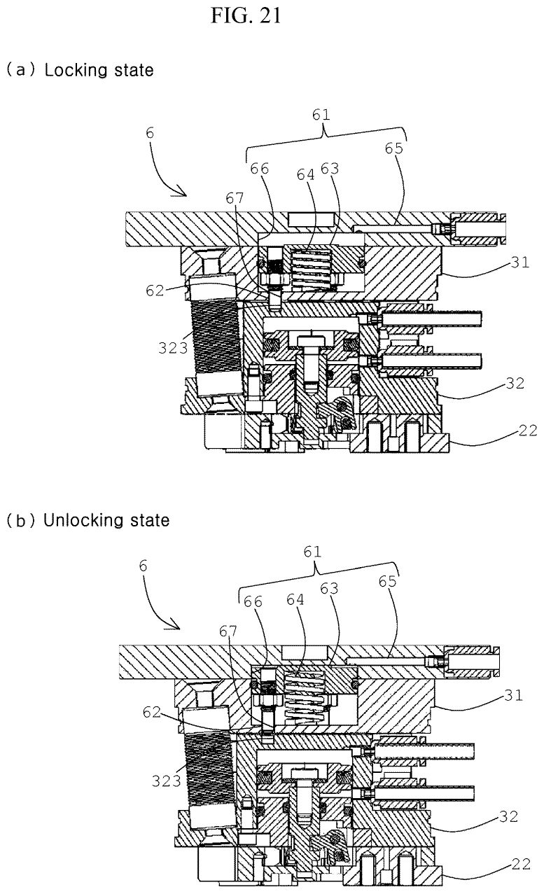

The option 3 is a locking mechanism 6 for locking the oscillation of the lower structure 32 while the assembling machine 10 carries the object 11 gripped by the gripping finger 21. In detail, as shown in FIG. 21(a) and (b), it has a locking actuator 61 provided in the upper structure 31 and a lock pin 62 slidingly driven in the vertical direction by the actuator 61.

The locking actuator 61 comprises a lock piston member 63 vertically moving in an air cylinder 66, a return spring 64 for biasing the lock piston member 63 upward, and an air port 65 supplying compressed air into the air cylinder 66. Also, three lock pins 62 are fixed at equal angular intervals in the circumferential direction in a state of projecting so as to be suspended from the lower surface of the lock piston member 63. A through-hole 67 is provided at a position corresponding to each lock pin 62 on the bottom surface of the air cylinder 66, and a pin hole 323 is provided at a position communicating with each through-hole 67 on the upper surface of the lower structure 32.

With the above configuration, when compressed air is supplied into the air cylinder 66 from the air port 65, the lock pin 62 drops together with the lock piston member 63 as shown in FIG. 21(a). Consequently, each lock pin 62 is inserted through the through hole 67 and projected downward from the lower surface of the upper structure 31 to be fitted into the pin hole 323 of the lower structure 32 (lock position). On the other hand, if the supply of compressed air is stopped, the return spring 64 raises the lock piston member 63 as shown in FIG. 21(b). Consequently, each lock pin 62 is pulled out from the pin hole 323 and the through hole 67 and retreated into the upper structure 31 (unlock position).

According to the locking mechanism 6 of the option 3 as described above, while the assembling machine 10 carries the object 11 gripped by the gripping finger 21 to the press-fitting position, the locking actuator 61 projects each lock pin 62 to the locking position and locks it. By locking by the plurality of lock pins 62, not only the oscillation of the lower structure 32 with respect to the upper structure 31 but also rotational vibration and torsional vibration with respect to the center axis can be prevented. Therefore, the cycle time from completion of conveyance to assembly is shortened. Also, since the oscillation does not exceed a correctable range of the center error, the occurrence of assembly failure can be prevented.

On the other hand, when the assembling machine 10 press-fits the object 11 gripped by the gripping finger 21 into the fitting hole 12, the locking actuator 61 retracts each lock pin 62 to the unlock position and unlocks it. Consequently, since the lower structure 32 is brought into a state capable of freely oscillating with respect to the upper structure 31, the center error can surely be corrected.

In addition, the locking actuator 61 is not limited to the above configuration, but may be a linear actuator such as a solenoid. Also, the means for moving the locking piston member 63 to the unlocking position (upward) is not limited to the return spring 64, but may be a double action type by also providing an air supply port at the lower side of the air cylinder 66. In addition, in this option 3, three lock pins 62 are provided at equal angular intervals in the circumferential direction, but it is not limited to this configuration and may be a plurality of them.

### (4) Option 4: Load Cell Mechanism

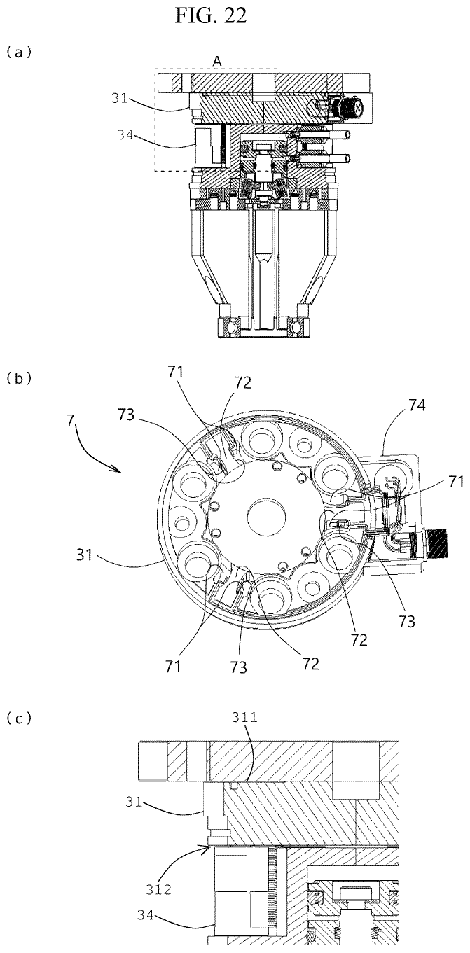

The option 4 is a load cell mechanism 7 for measuring the magnitude of press-fitting reaction force (load) generated in real time when the object 11 is press-fitting into the fitting hole 12. In detail, as shown in FIG. 22(b), the load cell mechanism 7 comprises a load detection part 72 sandwiched between a pair of through holes 71 penetrating a peripheral edge part of the upper structure 31 in the vertical direction, a strain gauge 73 fixed onto an inner wall surface of the through hole 71, and a junction box 74 outputting a voltage proportional to a change in resistance due to the strain of the strain gauge 73.

Also, as shown in FIG. 22(c), on the upper surface of the upper structure 31, a step surface 311 provided at an interval equal to or less than the elastically deformable length of the load detection part 72 is provided to face the mounting surface to be mounted on the assembling machine 10. A limiter gap 312 for rockably supporting the lower structure 32 is provided between the lower surface of the upper structure 31 and the upper surface of the limiter 34.

With the above constitution, when the elastic body 33 is compressed by press-fitting reaction force when the object 11 is pressed into the fitting hole 12, the upper surface of the limiter 34 and the lower surface of the upper structure 31 are relatively close to each other. Consequently, the press-fitting reaction force is transmitted to the upper structure 31 through the elastic body 33 and the limiter 34, so that the load detection part 72 is elastically deformed. As a result, a resistance value changed according to the elastic deformation of the strain gauge 73 is outputted to the junction box 74 to measure the load.

In this case, since the step surface 311 is provided at the interval equal to or less than the elastically deformable length of the load detecting part 72, there is no possibility of breaking by applying a great press-in reaction force to the upper structure 31. In addition, the press-fitting reaction force transmitted by the elastic body 33 is detected until the limiter gap 312 becomes zero.

According to the load cell mechanism 7 of the option 4 as described above, the magnitude of the press-in reaction force (load) generated when the object 11 is press-fitted into the fitting hole 12 can be measured in real time, and excessive press-fitting reaction force can be automatically detected. Also, as the load cell mechanism 7 is built in the upper structure 31, cost and labor can be reduced compared with installation between the upper structure 31 and the assembling machine 10.

### (5) Option 5: Foreign Matter Intrusion Prevention Mechanism

The option 5 is a foreign matter intrusion prevention mechanism 8 for preventing foreign matter such as dust from entering the inside of the gripping device 1A.

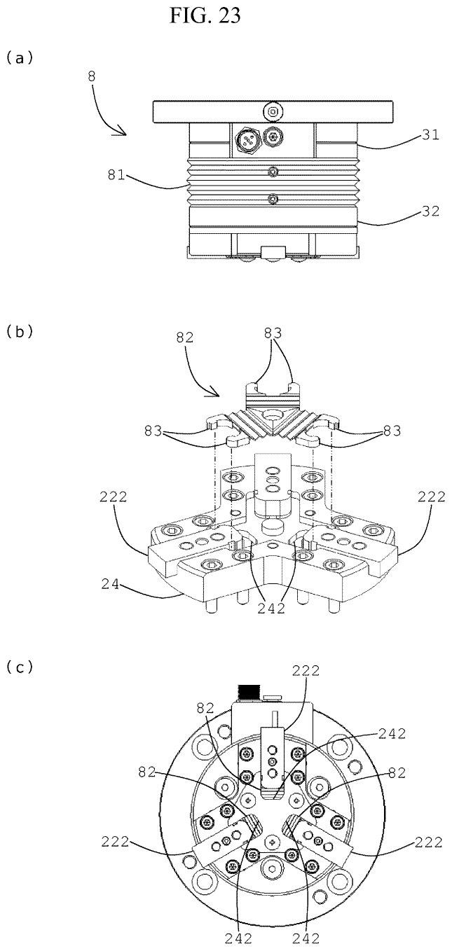

In detail, as shown in FIG. 23(a), a side cover 81 for preventing intrusion of foreign matter formed in a cylindrical and bellows shape is provided to surround the space between the upper structure 31 and the lower structure 32. Consequently, foreign matter such as dust can be prevented from entering between the upper structure 31 and the lower structure 32 without hindering the rocking operation of the lower structure 32 with respect to the upper structure 31.

Also, as shown in FIG. 23(b), a bellows-like foreign matter intrusion preventing bottom cover 82 is provided to close gap between the slide part 222 and the sliding through groove 242 and to have a locking claw 83 locked to the base end part of the slide part 222. According to the foreign matter intrusion preventing bottom cover 82, as shown in FIG. 23(c), the gap between the slide part 222 and the sliding through groove 242 is closed without hindering the opening and closing operation of the gripping finger 21, and foreign matter such as dust can be prevented from entering the gripping device 1A.

In addition, the gripping device 1 is not limited to the embodiments and the options described above and can be changed appropriately. For example, although the structure having three gripping fingers 21 is explained in the first to third embodiments described above and the structure having four gripping fingers 21 is explained in the fourth to fifth embodiments, the number of the gripping fingers 21 may be appropriately increased or decreased as long as the object can be gripped.

1. A gripping device attached to an assembling machine for gripping and press-fitting an object into a predetermined fitting hole, the gripping device comprising:
a gripping finger opening and closing mechanism for opening and closing a plurality of gripping fingers for gripping the object; and
a center error correction mechanism for correcting center position when press-fitting the object into the fitting hole,
wherein
the center error correction mechanism comprises an upper structure fixed to the assembling machine, a lower structure provided swingably to the upper structure through a plurality of elastic bodies, and a limiter provided between the upper structure and the lower structure for limiting press-fitting force acting on the elastic bodies at least during center position correction or press-fitting when press-fitting the object into the fitting hole, and
the gripping finger opening and closing mechanism comprises a plurality of gripping finger fixed slide members provided so as to slide in the radial direction with respect to the center of the lower structure for detachably fixing each of the gripping fingers, and an actuator for slidably moving the plurality of gripping finger fixed slide members in radial direction in accordance with the size of the object, so that
when the object is press-fitted into the fitting hole, the press-fitting force acting on the plurality of gripping fingers acts on the assembling machine through the plurality of gripping finger fixed slide members, the lower structure, the plurality of elastic bodies, the limiter and the upper structure.

2. The gripping device of claim 1, wherein the gripping finger fixed slide member has a gripping finger fixing part for fixing the gripping finger and a slide part having a wider width than the gripping finger fixing part, and
the gripping finger opening and closing mechanism has a support cover provided with a sliding fitting groove fixed to the lower structure and slidably fitting the slide part and a sliding through groove for slidably penetrating the gripping finger fixing part, a driving rod moved up and down by the actuator, and an L-shaped link member whose one end is linked to the driving rod and the other end is linked to the gripping finger fixed slide member for converting the vertical motion of the driving rod into the sliding motion of the gripping finger fixed slide member by rotating around a substantially horizontal rotary shaft provided in the lower structure.

3. The gripping device of claim 1, wherein the gripping finger fixed slide member has a gripping finger fixing part fixing the gripping finger and a slide part having a wider width than the gripping finger fixing part, and a T-shaped inclined groove having at the base end part of the slide part an inclined guide surface inclined at a predetermined inclination angle and an inclined surface parallel to the inclined guide surface and formed into a substantially T-shaped cross section,
the gripping finger opening and closing mechanism has T-shaped slots provided in the lower structure and having a substantially T-shaped cross section for slidably fitting the gripping finger fixed slide members and radial arm members vertically moved by the actuator and radially extended toward each of the gripping finger fixed slide members, and
a T-shaped inclined piece provided at each end of the radial arm members and having a substantially T-shaped cross section to have an inclined surface parallel to the inclined guide surface and the inclined surface of the T-shaped inclination groove, and sliding along the inclined guide surface and the T-shaped inclined groove for converting the vertical motion of the radial arm members into sliding motion of the gripping finger fixed slide members.

4. The gripping device of claim 1, wherein the gripping finger opening and closing mechanism has sliding through grooves provided in the lower structure and enabling the gripping finger fixed slide members to slidably penetrate, slide covers fixed to the upper surface of the gripping finger fixed slide members which penetrate into the sliding through grooves, a driving rod moved up and down by the actuator, a pair of wire hooks fixed at the upper and lower positions of the driving rod, a pair of horizontally fixed rollers rotatably supported around rotating shafts in an approximately horizontal direction at both ends of the sliding through grooves, and a driving wire having one end and the other end fixed to each of the wire hooks and intermediate parts fastened and fixed between the slide cover and the gripping finger fixed slide members and wound around the pair of horizontally fixed rollers for converting vertical motion of the driving rod into sliding motion of the gripping finger fixed slide members.

5. The gripping device of claim 1, wherein the gripping finger opening and closing mechanism has sliding through grooves provided in the lower structure and enabling the gripping finger fixed slide members to slidably penetrate, slide covers fixed to the upper surface of the gripping finger fixed slide members which penetrate the sliding through grooves, a pair of vertically fixed rollers arranged outside the sliding direction of the sliding through grooves respectively and rotatably supported around rotating shafts in approximately vertical direction, a driving pulley rotatably driven around a driving shaft in approximately vertical direction by the actuator which is fixed to the upper structure, a driven pulley provided in the lower structure and rotated in interlock with the driving pulley, an intermediate pulley provided between the driving pulley and the driven pulley and slidably connecting the driven pulley to the driving pulley in two directions orthogonal to each other, and a driven wire having one end and the other end fixed to the driven pulley and intermediate parts fixed to the slide covers and wound around the pair of vertically fixed rollers for converting rotational motion of the driven pulley into sliding motion of the gripping finger fixed slide members.

6. The gripping device of claim 1, wherein the gripping finger opening and closing mechanism has sliding through grooves provided in the lower structure and enabling the gripping finger fixed slide members to slidably penetrate, slide covers fixed to the upper surfaces of the gripping finger fixed slide members which penetrate the sliding through grooves, a pair of vertically fixed rollers arranged outside the sliding direction of the sliding through grooves respectively and rotatably supported around rotating shafts in an approximately vertical direction, a rotary pulley rotated and driven around a driving shaft in an approximately vertical direction by the actuator fixed to the lower structure, and a driving wire having one end and the other end each fixed to the rotary pulley and intermediate parts fixed to the slide covers and wound around the pair of vertically fixed rollers for converting the rotational motion of the rotary pulley into sliding motion of the gripping finger fixed slide members.

7. The gripping device of claim 1, wherein the gripping finger fixed slide member has an opening and closing position detection member and the gripping device further comprises an open position detection sensor for detecting the opening and closing position detection member when the gripping finger fixed slide member is in an open position and a closed position detection sensor for detecting the opening and closing position detection member when the gripping finger fixed slide member is a closed position.

8. The gripping device of claim 1 further comprising a displacement detection mechanism provided on the gripping finger fixed slide member for detecting displacement in a sliding direction.

9. The gripping device of claim 1 further comprising a plurality of locking pins slid in the vertical direction between a locking position projecting downward from the lower surface of the upper structure and an unlocking position retreated inside the upper structure, a locking actuator projecting the plurality of lock pins to the locking position while the assembling machine carries the object gripped by the gripping fingers to a press-fitting position and retreating the plurality of locking pins to the unlocking position when the assembling machine press-fits the object gripped by the gripping finger into the fitting hole.

10. The gripping device of claim 1 further comprising a load detection part sandwiched between a pair of through holes penetrating a peripheral edge part of the upper structure in the vertical direction and a strain gauge fixed to an inner wall surface of the through hole, and
wherein a step surface with an interval equal to or less than the elastically deformable length of the load detection part is provided on the upper surface of the upper structure.

11. The gripping device of claim 1 further comprising a foreign matter intrusion preventing side cover formed in a cylindrical and bellows shape and surrounding the space between the upper structure and the lower structure.

12. The gripping device of claim 2 further comprising a bellows-like foreign matter intrusion preventing bottom cover fixed to approximately the center of the support cover and having a locking claw locked to a base end part of the slide part for closing gap between the slide part and the sliding through groove.

13. An assembling machine equipped with the gripping device of claim 1.
